(19) United States
(12) Patent Application Publication
(10) Pub. No.: US 2009/0131609 A1
(43) Pub. Date: May 21, 2009

(54) Episulfide Group-Substituted Silicon Compound and Thermosetting Resin Composition Containing Same

(76) Inventors: Mitsukazu Ochi, Suita (JP); Koji Nakayama, Tokyo (JP)

Correspondence Address: Nields, Lemack & Frame, LLC, 176 E. Main Street, Suite #5, Westborough, MA, 01581, US

(21) Appl. No.: 11/988,525

(22) PCT Filed: Jul. 24, 2006
(86) PCT No.: PCT/JP2006/314569

§ 371 Date: Jan. 9, 2008

(30) Foreign Application Priority Data
Jul. 27, 2005 (JP) 2005-217085

(51) Int. Cl. C08G 65/48; C07F 7/21; C08G 77/00; C08L 63/02

(52) U.S. Cl. 525/534; 549/4; 528/37

(57) ABSTRACT

Disclosed is an episulfide group-substituted silicon compound (A) having a backbone structure represented by the following formula (1).

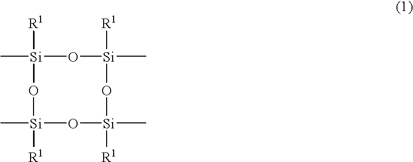

(1) (In the formula, R¹s respectively represent a substituent having an episulfide group, an unsubstituted or unsaturated acyloxy group-substituted (C₁-C₁₀) alkyl group or an aryl group. R¹s may be the same as or different from one another, but at least one R¹ in a molecule is a substituent having an episulfide group.)

### TECHNICAL FIELD

The present invention relates to a novel silicon compound. More specifically, the present invention relates to a composition which provides a thermosetting resin excellent in transparency, heat resistance and adhesive properties and usable for various insulating materials for electrical and electronic parts, various composite materials including laminate (printed wiring board) and FRP (fiber-reinforced plastic), adhesives, paints, and the like.

### BACKGROUND ART

Epoxy resins have excellent heat resistance, electric properties, dynamic properties and the like and therefore they are widely used in the fields of various electrical and electronic parts, structural materials, adhesives, paints and the like. In addition, in accordance with recent development of electrical and electronic fields, higher performance has come to be required of epoxy resins. Particularly, epoxy resins having further improved heat resistance have been demanded. Besides, in accordance with trend for high-density and fine-pitch wiring patterns in printed wiring boards, improvement in adhesive properties with copper foils to be processed into wiring is demanded.

In order to improve heat resistance of an epoxy resin, there is a method of increasing functional group density in the epoxy resin, thereby increasing crosslink density in the cured product. There are also a method of improving structure of the epoxy resin itself, for example, by introducing a stiff skeleton into the resin skeleton and a method of filling the epoxy resin with fillers such as glass fibers, silica particles and mica. However, these methods have not provided sufficient effects for improving heat resistance.

As another method for improving heat resistance of epoxy resins, Patent Document 1 describes a resin comprising an alkoxy group-containing silane-modified epoxy compound which is obtained by subjecting a bisphenol A type epoxy resin and a hydrolyzable alkoxysilane to dealcoholization reaction.

There is also described in Patent Document 2 and Patent Document 3 a method of improving adhesive properties with a metal using a compound having an episulfide group. Patent Document 4 describes an epoxy group-containing silicon compound and a composition comprising the same.

Patent Document 1: JP-A-2001-59013

Patent Document 2: JP-A-8-269043

Patent Document 3: JP-A-11-279519

Patent Document 4: JP-A-2004-43696

### DISCLOSURE OF THE INVENTION

However, resin compositions which are superior to the resin compositions described in Patent Documents 1 to 4 in heat resistance and adhesive properties are demanded.

An object of the present invention is to provide a novel episulfide group-substituted silicon compound which can provide cured products excellent in transparency, heat resistance and adhesive properties and a thermosetting resin composition using the same.

The present inventors have conducted intensive studies in order to solve the above problems and consequently reached the present invention. That is, the present invention relates to the following attributes 1) to 6).

1) An episulfide group-substituted silicon compound (A) having a skeletal structure of following formula (1):

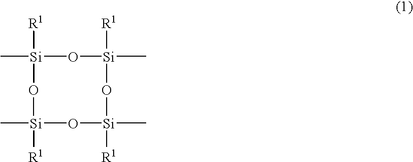

wherein R¹ represents a substituent group having an episulfide group; an unsubstituted or unsaturated acyloxy-group substituted (C1-C10) alkyl group; or an aryl group, and although R¹ may be the same or different from each other, at least one in one molecule is a substituent group having an episulfide group.
2) The episulfide group-substituted silicon compound (A) according to the above item 1), wherein the substituent group having an episulfide group is a (C1-C4) alkyl group substituted with an epithiopropoxy group and/or a (C1-C6) alkyl group substituted with a (C5-C8) cycloalkyl group having an episulfide group.
3) The episulfide group-substituted silicon compound (A) according to the above item 1) or 2), which is obtained by a production process comprising reacting an epoxy compound (2) having a skeletal structure of following formula (2a) with a sulfidizing agent to substitute an oxygen atom in an epoxy ring with a sulfur atom,

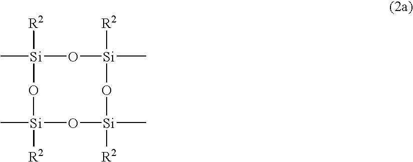

wherein R² represents a substituent group having an epoxy group; an unsubstituted or unsaturated acyloxy-group substituted (C1-C10) alkyl group; or an aryl group, and although R² may be the same or different from each other, at least one in one molecule is a substituent group having an epoxy group.
4) The episulfide group-substituted silicon compound (A) according to the above item 3, wherein the epoxy compound (2) is obtained by cohydrolysis condensation of epoxy-group containing alkoxy silicon compounds represented by following formula (2b) or by cohydrolysis condensation of an epoxy-group containing alkoxy silicon compound represented by following formula (2b) with an alkoxy silicon compound represented by following formula (2c),

XSi(OR³)₃ (2b)

wherein X represents a substituent group having an epoxy group, and R³ represents a (C1-C4) alkyl group;

R⁴Si(OR⁵)₃ (2c)

wherein R⁴ represents an unsubstituted or unsaturated acyloxy-group substituted (C1-C10) alkyl group; or an aryl group, and R⁵ represents a (C1-C4) alkyl group.
5) The episulfide group-substituted silicon compound (A) according to the above item 3) or 4), wherein the substituent group having an epoxy group is a (C1-C4) alkyl group substituted with a glycidoxy group and/or a (C1-C6) alkyl group substituted with a (C5-C8) cycloalkyl group having an epoxy group.
6) A thermosetting resin composition comprising an episulfide group-substituted silicon compound (A) according to any one of the above items 1) to 5); and a curing agent (B).
7) The thermosetting resin composition according to the above item 6) further comprising a curing accelerator (C); and an epoxy resin (D) different from the epoxy compound (2).
8) A cured product obtained by curing a thermosetting resin composition according to the above item 6) or 7).

The episulfide group-substituted silicon compound of the present invention is excellent in transparency, heat resistance and adhesive properties and can provide a thermosetting resin composition having a high curing rate which becomes a cured product noticeably useful in application of electrical and electronic device materials such as printed wiring boards, semiconductor encapsulating materials, transparent sealants for optical elements and adhesives in which the above characteristics are demanded.

### BRIEF DESCRIPTION OF THE DRAWING

FIG. 1 shows a graph which plots dynamic storage elastic modulus of the thermosetting resin compositions of Examples 3 and 4 and the thermosetting resin composition of Comparative Example 1 measured while elevating temperature.

### BEST MODE FOR CARRYING OUT THE INVENTION

The episulfide group-substituted silicon compound (A) of the present invention has a skeletal structure of the above formula (1), wherein R¹ represents a substituent group having an episulfide group; an unsubstituted or unsaturated acyloxy-group substituted (C1-C10) alkyl group; or an aryl group, and although R¹ may be the same or different from each other, at least one in one molecule is a substituent group having an episulfide group.

The substituent group having an episulfide group in the present invention is not limited in particular as long as an episulfide group is contained. Preferably included are a (C1-C4) alkyl group substituted with an epithiopropoxy group, an epithiopropyl group or a (C1-C6) alkyl groups substituted with a (C5-C8) cycloalkyl group having an episulfide group. Particularly preferably included are a (C1-C4) alkyl group substituted with an epithiopropoxy group or a (C1-C6) alkyl group substituted with a (C5-C8) cycloalkyl group having an episulfide group. The (C5-C8) cycloalkyl group having an episulfide group is a bicyclo compound in which episulfide is condensed with a (C5-C8) alicyclic compound.

In the present invention, examples of the (C1-C10) alkyl group which constitutes an unsubstituted or unsaturated acyloxy-group substituted (C1-C10) alkyl group include linear or branched alkyl groups such as methyl group, ethyl group, n-propyl group, i-propyl group, n-butyl group, t-butyl group, n-pentyl group, i-pentyl group, n-hexyl group, n-octyl group, 2-ethylhexyl group, n-nonyl group and n-decyl. The linear or branch (C1-C6) alkyl group is preferable, which specifically includes methyl group, ethyl group, n-propyl group, i-propyl group, n-butyl, t-butyl, n-pentyl group and i-pentyl group.

In addition, in the present invention, the (C1-C4) alkyl group which constitutes a (C1-C4) alkyl group substituted with an epithiopropoxy group includes a (C1-C4) alkyl group in the (C1-C10) alkyl group mentioned above. Examples thereof include methyl group, ethyl group, n-propyl group, i-propyl group, n-butyl group, i-butyl group and t-butyl group.

In the present invention, the aryl group includes a (C6-C14) aryl group. Specific examples thereof include phenyl group and naphthyl group, and phenyl group is preferable.

Specific examples of the unsaturated acyloxy group in the unsaturated acyloxy-group substituted (C1-C10) alkyl group in the present invention include an acryloxy group and a methacryloxy group.

The episulfide group-substituted silicon compound (A) of the present invention can be produced, for example, by reacting an epoxy compound (2) having a skeletal structure of the above formula (2a), wherein R² represents a substituent group having an epoxy group; an unsubstituted or unsaturated acyloxy-group substituted (C1-C10) alkyl group; or an aryl group, and although R² may be the same or different from each other, at least one in one molecule is a substituent group having an epoxy group, with a sulfidizing agent.

The epoxy compound (2) can be produced, for example, by cohydrolysis condensation of epoxy-group containing alkoxy silicon compounds represented by the above formula (2b), wherein, X represents a substituent group having an epoxy group, and R³ represents a (C1-C4) alkyl group, or by cohydrolysis condensation of an epoxy-group containing alkoxy silicon compound represented by following formula (2b) with an alkoxy silicon compound represented by the above formula (2c), wherein, R⁴ represents an unsubstituted or unsaturated acyloxy-group substituted (C1-C10) alkyl group; or an aryl group, and R⁵ represents a (C1-C4) alkyl group.

In general formula (2b), there is no limitation imposed in particular on the substituent group having an epoxy group as long as it has an epoxy group. Examples thereof include a (C1-C4) alkyl group substituted with a glycidoxy group such as a β-glycidoxyethyl group, a γ-glycidoxypropyl group and a γ-glycidoxybutyl group; a glycidyl group; and a (C1-C6) alkyl group substituted with a (C5-C8) cycloalkyl group having an epoxy group such as a β-(3,4-epoxycyclohexyl)ethyl group, a γ-(3,4-epoxycyclohexyl)propyl group, a β-(3,4-epoxycycloheptyl)ethyl group, a β-(3,4-epoxycyclohexyl)propyl group, a β-(3,4-epoxycyclohexyl)butyl group and a β-(3,4-epoxycyclohexyl)pentyl group. Among these, preferably included are a (C1-C4) alkyl group linked with a glycidoxy group, a (C5-C8) cycloalkyl group substituted with a (C1-C4) alkyl group having an epoxy group. Specific examples thereof include a β-glycidoxy ethyl group, a γ-glycidoxypropyl group and a β-(3,4-epoxycyclohexyl)ethyl group.

The (C1-C4) alkyl group in R³ of formula (2b) or in R⁵ of formula (2c) includes similar groups exemplified as a (C1-C4) alkyl group which constitutes a (C1-C4) alkyl group substituted with an epithiopropoxy group in the above formula (1). Specific examples thereof include methyl group, ethyl group, n-propyl group, i-propyl group, n-butyl group, i-butyl group and t-butyl group. Methyl group or ethyl group is preferable from the point of compatibility, reactivity and the like.

Preferable examples of the compound represented by above formula (2b) include β-glycidoxyethyltrimethoxysilane, β-glycidoxyethyltriethoxysilane, γ-glycidoxypropyltrimethoxysilane, γ-glycidoxypropyltriethoxysilane, β-(3,4-epoxycyclohexyl)ethyltrimethoxysilane and β-(3,4-epoxycyclohexyl)ethyltriethoxysilane.

These alkoxy silicon compounds represented by formula (2b) may be used singly or in a combination of two or more kinds.

The unsubstituted or unsaturated acyloxy-group substituted (C1-C10) alkyl group; or an aryl group in R⁴ of a compound represented by above formula (2c) includes similar groups exemplified as the unsubstituted or unsaturated acyloxy-group substituted (C1-C10) alkyl group; or aryl group in R¹ of the above episulfide group-substituted silicon compound (A) and the preferred groups are also the same.

Specific examples of the compounds represented by above formula (2c) include methyltrimethoxysilane, methyltriethoxysilane, isobutyltrimethoxysilane, isobutyltriethoxysilane, hexyltrimethoxysilane, hexyltriethoxysilane, octyltrimethoxysilane, octyltriethoxysilane, decyltrimethoxysilane, decyltriethoxysilane, phenyltrimethoxysilane, phenyltriethoxysilane, 3-metacryoxypropyltrimethoxysilane, 3-metacryoxypropyltriethoxysilane, 3-acryoxypropyltrimethoxysilane and 3-acryoxypropyltriethoxysilane.

These alkoxy silicon compounds represented by formula (2c) may be used singly or in a combination of two or more kinds.

The addition of water to be added in the cohydrolysis condensation of epoxy-group containing alkoxy silicon compounds represented by the above formula (2b), or in the cohydrolysis condensation of an epoxy-group containing alkoxy silicon compound represented by the above formula (2b) with an alkoxy silicon compound represented by the above formula (2c) is preferably 0.1 to 1.5 mol equivalent, and particularly preferably 0.2 to 1.2 mol equivalent for 1 mol of alkoxy group of the whole reaction system.

It is preferable to use a catalyst in the reaction. For the catalyst, those conventionally known as catalysts for promoting condensation of alkoxysilanes and not opening the ring of an epoxy group can be used. Specific examples include inorganic bases such as sodium hydroxide, potassium hydroxide, lithium hydroxide, cesium hydroxide, sodium carbonate, potassium carbonate, sodium hydrogen carbonate and potassium hydrogen carbonate; ammonia; organic bases such as tetramethylammonium hydroxide; metal alkoxides; and organic acid tin such as dibutyltin dilaurate. Of these, inorganic bases and organic acid tin are particularly preferable.

When a catalyst is used, the amount is about 5×10⁻⁴ to 7.5 wt %, preferably about 1×10⁻³ to 5 wt % based on the total weight of the alkoxy silicon compound in the reaction system.

The reaction can be performed with or without a solvent. When a solvent is used, there is no limitation imposed particularly on the solvent as long as it dissolves alkoxy silicon compounds represented by formula (2b) and formula (2c). Examples of such solvents include aprotic polar solvents such as dimethylformamide, dimethylacetamide, tetrahydrofuran, methyl ethyl ketone, methyl isobutyl ketone; and aromatic hydrocarbons such as toluene and xylene. Among these, aprotic polar solvents are preferable.

When a solvent is used, there is no limitation imposed in particular on the amount as long as it is the range in which the reaction proceeds smoothly. Such a solvent is usually used in an amount of about 50 to 900 parts by weight based on 100 parts by weight of the compounds represented by formula (2b) and formula (2c) in total.

The reaction temperature in the reaction depends on the amount of the catalyst but it is usually 20 to 160° C. and more preferably 40 to 140° C. The reaction time is usually 1 to 12 hours.

The molecular weight of the epoxy compound (2) obtained by the reaction is preferably about 400 to 50000, more preferably about 750 to 30000 in terms of weight average molecular weight. When the weight average molecular weight is less than 400, curability of the composition tends to deteriorate. On the other hand, when it is more than 50000, the viscosity of the composition may rise too high.

The episulfide group-substituted silicon compound (A) of the present invention can be obtained by reacting the above epoxy compound (2) with a sulfidizing agent to substitute an oxygen atom in the epoxy ring with a sulfur atom. Therefore, preferable weight average molecular weight of the episulfide group-substituted silicon compound (A) is the same as that of the epoxy compound (2). The preferable sulfidizing agent is not limited in particular as long as it enables such a substitution reaction and includes thiourea, thiocyanic acid salts (potassium thiocyanate, etc.).

The substitution reaction can be performed with or without a solvent. When a solvent is used, there is no limitation imposed particularly on the solvent as long as it dissolves the above epoxy compound (2). Examples of such solvents include aprotic polar solvents such as dimethylformamide, dimethylacetamide, tetrahydrofuran, methyl ethyl ketone and methyl isobutyl ketone; alcohols such as methanol and ethanol; and aromatic hydrocarbons such as toluene and xylene. Among these, aprotic polar solvents and alcohols are preferable. When a solvent is used, there is no limitation imposed in particular on the amount as long as it is the range in which the reaction proceeds smoothly. Such a solvent is usually used in an amount of about 50 to 3000 parts by weight based on 100 parts by weight of the epoxy compound (2) used in the reaction in total.

The reaction temperature in the substitution reaction depends on the concentration of the substrate, the kind of the sulfidizing agent to be used and the like but it is usually 10 to 100° C. and more preferably 20 to 80° C. The reaction time is usually 1 to 24 hours.

Episulfidation of the epoxy group in a desired ratio can be attained by appropriately controlling the amount of the sulfidizing agent in the substitution reaction.

The ratio of episulfide group in the episulfide group-substituted silicon compound (A) contained in the thermosetting resin composition of the present invention to the epoxy group of the above epoxy compound (2) is preferably 5 to 100%, particularly preferably 7 to 95%.

The thermosetting resin composition of the present invention contains the above episulfide group-substituted silicon compound (A) and curing agent (B).

As curing agent (B), usually, there can be used without particular limitation amine type compounds, acid anhydride type compounds, amide type compounds, phenol type compounds and the like which have been used as a curing agent for an epoxy resin. Specific examples thereof include tertiary amines such as diaminodiphenylmethane, diethylenetriamine, triethylenetetramine, diaminodiphenylsulfone, isophorone diamine and benzyldimethylamine, dicyandiamide, tetraethylenepentamine, ketimine compounds, polyamide resins synthesized from dimmer of linolenic acid and ethylene diamine, phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, methylhexahydrophthalic anhydride, bisphenols, polycondensates of phenols (phenol, alkyl-substituted phenol, naphthol, alkyl-substituted naphthol, dihydroxybenzene, dihydroxynaphthalene, etc.) and various aldehydes, polymerization products of phenols and various diene compounds, polycondensates of phenols and aromatic dimethylols, condensates of bismethoxymethylbiphenyl and naphthols or phenols, biphenols and the modification products thereof, imidazoles, boron trifluoride-amine complex, guanidine derivatives, etc.

The amount of the curing agent is preferably 0.1 to 200 parts by weight and particularly preferably 0.2 to 180 parts by weight based on 100 parts by weight in total of the episulfide group-substituted silicon compound (A) and epoxy resin (D) which is an optional constituent and described later in the composition. When a tertiary amine is use as a curing agent, 0.3 to 20 parts by weight is preferable, and 0.5 to 10 parts by weight is particularly preferable.

Curing accelerator (C) may be contained in the thermosetting resin composition of the present invention as required. Examples the curing accelerator (C) include imidazoles such as 2-methylimidazole, 2-ethylimidazole and 2-ethyl-4-methylimidazole; tertiary amines such as 2-(dimethylaminomethyl)phenol and 1,8-diazabicyclo[5,4,0]undecene-7; phosphines such as triphenylphosphine; metal compounds such as tin octylate, and quaternary phosphonium salts. Such a curing accelerator (C) is used in an amount of 0.01 to 15 parts by weight based on 100 parts by weight in total of an episulfide group-substituted silicon compound (A) and an epoxy resin (D) which is an optional constituent and described later.

The thermosetting resin composition of the present invention may contain an epoxy resin (D) which is different from the epoxy compounds (2) as required. There is no particularly limitation on the epoxy resin (D), as long as it is an epoxy resin used for electric or electronic parts. Examples thereof include an epoxy resin obtained by glycidylating a compound having two or more phenolic hydroxyl groups.

Specific examples of the epoxy resin (D) include bisphenols such as tetrabromobisphenol A, tetrabromobisphenol F, bispenol A, tetramethylbisphenol F, bisphenol F, bisphenol S or bisphenol K; biphenols such as biphenol or tetramethylbiphenol; hydroquinones such as hydroquinone, methyl hydroquinone, dimethyl hydroquinone, trimethyl hydroquinone or di(t-butyl)hydroquinone, resorcinols such as resorcinol or methyl resorcinol; catechols such as catechol or methylcatechol; glycidylated products of dihydroxynaphthalenes such as dihydroxynaphthalene, dihydroxymethylnaphthalene or dihydroxydimethylnaphthalene; condensates of phenols or naphthols with aldehydes; condensates of phenols or naphthols with xylylene glycol; condensates of phenols with isopropenyl acetophenones, reaction products between phenols and dicyclopentadiene; glycidylated condensates of bismethoxymethyl biphenyl and naphthols or phenols; and epoxy group-containing silicon compounds. These compounds are commercially available or also obtainable by conventionally known methods. In addition, alicyclic epoxy resin such as EHPE-3150, CELLOXIDE 2021 (produced by Daicel Chemical Industries, Ltd.) and hydrogenerated bisphenol A type epoxy resin; or heterocyclic epoxy resins such as TEPIC, TEPIC-L, TEPIC-H and TEPIC-S (each available from Nissan Chemical Industries, Ltd.) can be used as epoxy resin (D). Those epoxy resins may be used singly or in a combination of two or more kinds.

When the epoxy resin (D) is used, the amount is about 5 to 60 wt %, preferably around 10 to 50 wt % in the thermosetting resin composition.

When the above epoxy resin (D) is used together with an episulfide group-substituted silicon compound (A) in the thermosetting resin composition of the present invention, the ratio of the episulfide group-substituted silicon compound (A) is preferably 10 to 95 wt % based on the total of the episulfide group-substituted silicon compound (A) and the epoxy resin (D).

Furthermore, various formulating ingredients such as fillers such as silica, alumina, glass fiber and talc, mold releasing agents, pigments, surface treatment agents, viscosity modifiers, plasticizers, stabilizers and coupling agents can be added to the thermosetting resin composition of the present invention as required.

The thermosetting resin composition of the present invention can be obtained by mixing each of the above constituents uniformly. The thermosetting resin composition of the present invention can be easily changed into its cured product by a method similar to those which have been heretofore known, and the present invention encompasses the cured product as well.

That is, for example, an episulfide group-substituted silicon compound (A) and a curing agent (B), and optionally a curing accelerator (C), an epoxy resin (D) and other formulating ingredients such as inorganic fillers as required are sufficiently blended, dispersed and degassed until they become uniform by use of an extruder, a kneader, a roll or the like so as to prepare the thermosetting resin composition of the present invention. The thermosetting resin composition can be molded by application, casting or by use of a transfer molding machine and the like and then can be heated at 80 to 200° C. for 2 to 10 hours to obtain a cured product.

In addition, the thermosetting resin composition of the present invention can be used as a varnish by dissolving it in a solvent. As such a solvent, there is no particular limitation as long as it dissolves each of the above constituents of the thermosetting resin composition. Examples thereof include toluene, xylene, acetone, methyl ethyl ketone, methyl isobutyl ketone and dimethylformamide. The cured product of the present invention can be obtained by impregnating the varnish into a base material such as glass fibers, carbon fibers, polyester fibers, polyamide fibers, alumina fibers or paper, drying under heating to get a prepreg, and molding the prepreg by hot-pressing.

The solvent can be used in such an amount that the proportion of the solvent in the total weight of the thermosetting resin composition and the solvent can be usually 10 to 70 wt %, preferably 15 to 65 wt %.

### EXAMPLES

The present invention is specifically described by way of working examples, but the present invention is not limited by these working examples. The unit “part” represents part by weight unless otherwise stated in the following. The physical property values were measured by the below methods.

(1) Weight average molecular weight: measured by gel permeation chromatography (GPC) method.

(2) Epoxy equivalent: measured by a method pursuant to JIS K-7236.

(3) Nuclear magnetic resonance spectrum: measured with JNM-ECA400 manufactured by JEOL Ltd., and a nuclear magnetic resonance spectrum (NMR) of ²⁹Si was measure for silicon.

### Synthesis Example 1

94.4 parts of γ-glycidoxypropyltrimethoxysilane and 188.8 parts of methyl isobutyl ketone were charged in a reaction vessel and heated to 80° C. After heating, 10.8 parts of 0.1 wt % potassium hydroxide aqueous solution was continuously dropped for 30 minutes. After completion of the dropping, the reaction was conducted for 5 hours at 80° C. After completion of the reaction, water washing was repeated until the used wash becomes neutral. Then the solvent was removed under reduced pressure to obtain 66 parts of an epoxy compound (2-1). The epoxy equivalent of the resultant compound was 170 g/eq., and the weight average molecular weight thereof was 2300. It was confirmed that epoxy ring was retained from the presence of the methine peak of an epoxy ring (in the vicinity of 3.2 ppm) in ¹H-NMR (CDCl₃ solution) of the epoxy compound (2-1) and that the methoxy group was substituted from the disappearance of the peak of a methoxy group (in the vicinity of 3.6 ppm). Further, as a result of measuring ²⁹Si—NMR (CDCl₃ solution) of the resultant compound, a peak attributable to the structure that three —O—Si were linked to Si was observed in the vicinity of −65 to −70 ppm.

### Synthesis Example 2

23.6 parts of γ-glycidoxypropyltrimethoxysilane, 40.0 parts of phenyltrimethoxysilane, 31.8 parts of methyl isobutyl ketone and 8.1 parts of 0.1 wt % potassium hydroxide aqueous solution were charged in a reaction vessel and heated to 80° C. After heating, the reaction was conducted for 5 hours at 80° C. After completion of the reaction, water washing was repeated until the used wash becomes neutral. Then the solvent was removed under reduced pressure to obtain 42 parts of an epoxy compound (2-2). The epoxy equivalent of the resultant compound was 440 g/eq., and the weight average molecular weight thereof was 3700. It was confirmed that epoxy ring was retained from the presence of the methine peak of an epoxy ring (in the vicinity of 3.2 ppm) in ¹H-NMR (CDCl₃ solution) of the epoxy compound (2-2) and that the methoxy group was substituted from the disappearance of the peak of a methoxy group (in the vicinity of 3.6 ppm). Further, as a result of measuring ²⁹Si—NMR (CDCl₃ solution) of the resultant compound, a peak attributable to the structure that three —O—Si were linked to Si was observed in the vicinity of −65 to −70 ppm.

### Example 1

25 parts of the epoxy compound (2-1) obtained in Synthesis Example 1 and 200 parts of methanol were charged into a reaction vessel and stirred at room temperature to dissolve the epoxy compound (2-1). A solution in which 16.7 parts of thiourea was dissolved in 100 parts of methanol was dropped for 45 minutes. After completion of the dropping, the temperature was elevated to 40° C. and reaction was conducted for 5 hours at 40° C. After completion of the reaction, 400 parts of methyl isobutyl ketone was added thereto and then washing with 300 parts of pure water was repeated five times. After the washing, the solvent was removed under reduced pressure to obtain 20 parts of an episulfide group-substituted silicon compound (A-1) of the present invention. Proton NMR measurement of this episulfide group-substituted silicon compound (A-1) was performed and it was confirmed that 40% of epoxy groups of the raw material was substituted with episulfide group from the integral ratio of methylene protons of episulfide group and epoxy group (peaks in the vicinity of 2.3 and 2.6 ppm for episulfide group and peaks in the vicinity of 2.7 and 2.8 ppm for epoxy group).

### Example 2

29.1 parts of the epoxy compound (2-2) obtained in Synthesis Example 2 and 200 parts of methanol were charged into a reaction vessel and stirred at room temperature to dissolve the epoxy compound (2-2). A solution in which 2.2 parts of thiourea was dissolved in 50 parts of methanol was dropped for 45 minutes. After completion of the dropping, the temperature was elevated to 40° C. and reaction was conducted for 5 hours at 40° C. After completion of the reaction, 400 parts of methyl isobutyl ketone was added thereto and then washing with 300 parts of pure water was repeated five times. After the washing, the solvent was removed under reduced pressure to obtain 21 parts of an episulfide group-substituted silicon compound (A-2) of the present invention. Proton NMR measurement of this episulfide group-substituted silicon compound (A-2) was performed and it was confirmed that 40% of epoxy groups of the raw material was substituted with episulfide group from the integral ratio of methylene protons of episulfide group and epoxy group (peaks in the vicinity of 2.3 and 2.6 ppm for episulfide group and peaks in the vicinity of 2.7 and 2.8 ppm for epoxy group).

### Examples 3 and 4

### Comparative Examples 1 and 2

The resultant episulfide group-substituted silicon compound (A-1 or A-2), an epoxy resin (D-1), an epoxy resin (D-2) and a curing agent (B) were weighted in ratios (parts) shown in Table 1 and blended uniformly to prepare thermosetting resin compositions. Thermosetting resin compositions which did not contain an episulfide group-substituted silicon compound (A) of the present invention were also prepared as Comparative Example 1 or 2.

TABLE 1

| Component | | | Comparative | Comparative |
|---|---|---|---|---|
| (part by weight) | Example 3 | Example 4 | Example 1 | Example 2 |
| A-1 | 106 | | | |
| A-2 | | 115 | | |
| Epoxy resin (D-1) | 60 | 50 | 100 | 50 |
| *1 | | | | |
| Epoxy resin (D-2) | | | | 50 |
| *2 | | | | |
| Curing agent (B) | 47 | 26 | 26 | 27 |
| *3 | | | | |

*1: Bisphenol A type epoxy resin; epoxy equivalent 190 g/eq
*2: Proper amounts of 3-glycidoxypropyltrimethoxysilane and water, dibutyltin dilaurate as a catalyst and tetrahydrofuran as a solvent were reacted at 80° C. for five hours according to Synthesis Example 1 of Patent Document 4. After completion of the reaction, the solvent was removed under reduced pressure to prepare an epoxy group-containing silicon compound (D-2)
*3: 4,4′-diaminodiphenylmethane

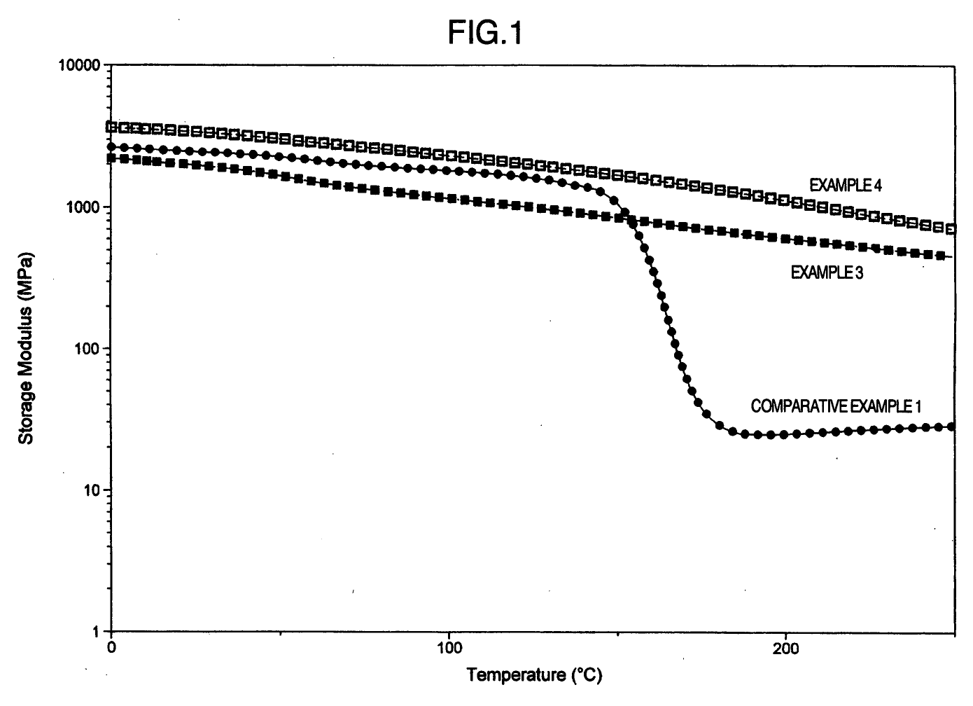

The prepared compositions were subjected to the following tests. The results are shown in FIG. 1 and Table 2.

### (Heat Resistance Evaluation)

The compositions prepared in Examples 3 and 4, and Comparative Example 1 were cast into a predetermined mold and heated at 80, 100, 150° C. for two hours, respectively, for two hours and then at 190° C. for four hours to obtain test pieces (cured products). The obtained test pieces (approximately 4 mm width, 3 mm thickness and 40 mm length) were subjected to the measurement of dynamic storage modulus by means of a dynamic viscoelasticity measuring apparatus (i.e. using DMA 2980 manufactured by TA Instruments Corporation, and measurement conditions including an amplitude of 15 μM, a frequency of 10 Hz, and a temperature elevation rate of 2° C./min.) to evaluate heat resistance. The results are shown in FIG. 1.

### (Adhesive Properties Evaluation)

80 parts of the composition prepared in each of Examples 3 and 4, and Comparative Examples 1 and 2 were dissolved in 20 parts of methyl ethyl ketone to prepare a varnish. By means of a bar coater, the varnish was applied to rolled copper foil (manufactured by Fukuda Metal Foil & Powder Co., Ltd.) having a thickness of 35 μm which had been subjected to surface roughening. After allowed to stand still in a drying furnace at 80° C. for three minutes, each sample was heated at 130° C. for 25 minutes under a pressure of 30 kg/cm² with a hot press, and then the temperature was elevated to 180° C. at a rate of 2.5° C./min. Test pieces for the evaluation of adhesive properties were obtained by heating for 90 minutes after the temperature reached 180° C. Adhesive properties were evaluated by subjecting the obtained test pieces to a tension test at a cross-head rate of 200 mm/min. The results are shown in Table 2.

TABLE 2

| | | | Comparative | Comparative |
|---|---|---|---|---|
| | Example 1 | Example 2 | Example 1 | Example 2 |
| Adhesive | 1.3 | 1.2 | 0.9 | 0.7 |
| properties | | | | |
| (kg/cm) | | | | |

The above results reveal that as for the cured products of the thermosetting resin composition containing an episulfide group-substituted silicon compound of the present invention, a noticeable improvement in dynamic storage modulus at elevated temperatures was recognized and the heat resistance thereof was improved as compared with a cured product using a conventional thermosetting epoxy resin whose dynamic storage modulus significantly deteriorated at elevated temperatures higher than about 150° C. (Comparative Example 1). In addition, it was demonstrated that the cured products according to the present invention provide more excellent performance in adhesive properties as compared with a cured product using a conventional thermosetting epoxy resin (Comparative Example 1) and a cured product of the thermosetting resin composition described in Patent Document 4 (Comparative Example 2).

### INDUSTRIAL APPLICABILITY

The episulfide group-substituted silicon compound of the present invention and the thermosetting resin composition containing the same are transparent and excellent in adhesive properties and heat-resistant and can be used as various materials for electrical and electronic parts such as printed wiring boards, semiconductor encapsulating materials, transparent sealant for optical elements, underfill materials, inter layer insulating material of electronic parts, printing ink, paints, various coating agents and adhesives.

1. An episulfide group-substituted silicon compound (A) having a skeletal structure of following formula (1): 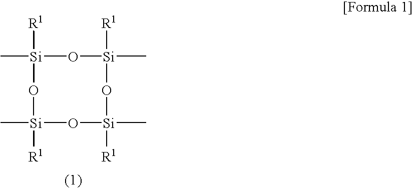
wherein R¹ represents a substituent group having an episulfide group; an unsubstituted or unsaturated acyloxy-group substituted (C1-C10) alkyl group; or an aryl group, and although R¹ may be the same or different from each other, at least one in one molecule is a substituent group having an episulfide group.

2. The episulfide group-substituted silicon compound (A) according to claim 1, wherein the substituent group having an episulfide group is a (C1-C4) alkyl group substituted with an epithiopropoxy group and/or a (C1-C6) alkyl group substituted with a (C5-C8) cycloalkyl group having an episulfide group.

3. The episulfide group-substituted silicon compound (A) according to claim 1 or 2, which is obtained by a production process comprising reacting an epoxy compound (2) having a skeletal structure of following formula (2a) with a sulfidizing agent to substitute an oxygen atom in an epoxy ring with a sulfur atom, 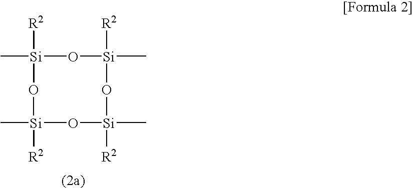
wherein R² represents a substituent group having an epoxy group; an unsubstituted or unsaturated acyloxy-group substituted (C1-C10) alkyl group; or an aryl group, and although R² may be the same or different from each other, at least one in one molecule is a substituent group having an epoxy group.

4. The episulfide group-substituted silicon compound (A) according to claim 3, wherein the epoxy compound (2) is obtained by cohydrolysis condensation of epoxy-group containing alkoxy silicon compounds represented by following formula (2b) or by cohydrolysis condensation of an epoxy-group containing alkoxy silicon compound represented by following formula (2b) with an alkoxy silicon compound represented by following formula (2c),
[Formula 3]
XSi(OR³)₃ (2b)
wherein X represents a substituent group having an epoxy group, and R³ represents a (C1-C4) alkyl group;
[Formula 4]
R⁴Si(OR⁵)₃ (2c)
wherein R⁴ represents an unsubstituted or unsaturated acyloxy-group substituted (C1-C10) alkyl group; or an aryl group, and R⁵ represents a (C1-C4) alkyl group.

5. The episulfide group-substituted silicon compound (A) according to claim 3 or 4, wherein the substituent group having an epoxy group is a (C1-C4) alkyl group substituted with a glycidoxy group and/or a (C1-C6) alkyl group substituted with a (C5-C8) cycloalkyl group having an epoxy group.

6. A thermosetting resin composition comprising an episulfide group-substituted silicon compound (A) according to any one of claims 1 to 5; and a curing agent (B).

7. The thermosetting resin composition according to claim 6 further comprising a curing accelerator (C); and an epoxy resin (D) different from the epoxy compound (2).

8. A cured product obtained by curing a thermosetting resin composition according to claim 6 or 7.
